(19) United States
(12) Patent Application Publication
(10) Pub. No.: US 2020/0087572 A1
(43) Pub. Date: Mar. 19, 2020

(54) SEMICONDUCTING LIGHT EMITTING NANOPARTICLE

(71) Applicant: Merck Patent GmbH, Darmstadt (DE)

(72) Inventors: Inbal DAVIDI, Modiin (IL); Alex IRZH, Jerusalem (IL); Nathan GRUMBACH, Efrat (IL); Miriam KOOLYK SHARABI, Jerusalem (IL); Shany NEYSHTADT, Jerusalem (IL); Alex RABKIN, Beer Sheva (IL); Hagai ARBELL, Mevaseret Zion (IL)

(73) Assignee: Merck Patent GmbH, Darmstadt (DE)

(21) Appl. No.: 16/469,712

(22) PCT Filed: Dec. 11, 2017
(86) PCT No.: PCT/EP2017/082129

§ 371 Date: Jun. 14, 2019

(30) Foreign Application Priority Data
Dec. 15, 2016 (EP) 16204440.8
May 18, 2017 (EP) 17171758.0

(51) Int. Cl. C09K 11/88; C09K 11/08; C09K 11/02

(52) U.S. Cl. CPC C09K 11/883; C09K 11/025; C09K 11/0883

(57) ABSTRACT

The present invention relates to a semiconducting light emitting nanoparticle; a process for synthesizing a semiconducting light emitting nanoparticle; composition, formulation and use of a semiconducting light emitting nanoparticle, an optical medium; and an optical device.

### FIELD OF THE INVENTION

The present invention relates to a semiconducting light emitting nanoparticle; a process for synthesizing a semiconducting light emitting nanoparticle; composition, formulation and use of a semiconducting light emitting nanoparticle, an optical medium; and an optical device.

### BACKGROUND ART

Semiconducting light emitting nanoparticles comprising a core and at least one shell layer are known in the prior art documents.

For example, as described in Hens et al., Chem. Materials, 2015, 27, 4893-4898, Jeong et al., Applied Physics Letters, 2012, 101, 7, 073107, Char et al., ACS Nano, 2016, 10(4), pp 4754-4762, U.S. Pat. No. 9,109,163 B2, ACS Nano, 2013, 7(10), pp 9019-9026, Chem. Mater., 2011, 23(20), pp 4459-4463, and WO 2016/146719 A1.

### Patent Literature

1. U.S. Pat. No. 9,109,163 B2
2. WO 2016/146719 A1

### Non Patent Literature

3. Hens et al., Chem. Materials, 2015, 27, 4893-4898
4. Jeong et al., Applied Physics Letters, 2012, 101, 7, 073107,
5. Char e al., ACS Nano, 2016, 10(4), pp 4754-4762
6. ACS Nano, 2013, 7(10), pp 9019-9026
7. Chem. Mater., 2011, 23(20), pp 4459-4463.

### SUMMARY OF THE INVENTION

However, the inventors newly have found that there is still one or more of considerable problems for which improvement is desired, as listed below.
1. A novel semiconducting light emitting nanoparticle comprising a core and at least one shell layer with lower self-absorption value, is desired.
2. A novel semiconducting light emitting nanoparticle comprising a core and at least one shell layer with improved volume ratio between the core and the shell of the semiconducting light emitting nanoparticle, is requested.
3. A novel semiconducting light emitting nanoparticle comprising a core and at least one shell layer with better Quantum Yield, still needs improvement.
4. A novel process for synthesizing a semiconducting light emitting nanoparticle comprising a core and at least one shell layer, which can more precisely control the volume ratio between the core and the shell of the semiconducting light emitting nanoparticle, is desired.
5. A novel process for synthesizing a semiconducting light emitting nanoparticle comprising a core and at least one shell layer, which can also control the crystallinity of the shell, is requested.
6. A novel semiconducting light emitting nanoparticle comprising a core and at least one highly crystalline shell layer, is desired.

The inventors aimed to solve one or more of the above mentioned problems 1 to 6.

Then it was found a novel semiconducting light emitting nanoparticle comprising a core and at least one shell layer, wherein the semiconducting light emitting nanoparticle has the self-absorption value 0.35 or less, preferably, in the range from 0.30 to 0.01, more preferably, from 0.25 to 0.05, even more preferably, from 0.23 to 0.12.

In another aspect, the present invention relates to a process for synthesizing the nanoparticle comprising following steps (a) and (b),

(a) preparing a core by providing at least a first and a second core precursor optionally in a solvent, preferably said first core precursor is a salt of the element of the group 12 or of the group 13 and said second core precursor is a source of an element of the group 15 of the periodic table, more preferably the element of the group 13 is In, Ga or a mixture of thereof, the element of the group 12 is Cd, Zn or mixture of thereof, and the element of the group 15 is P, or As, even more preferably said first core precursor is a salt of the element of the group 13 selected from In or Ga or a mixture of thereof,
(b) providing the core obtained in the step (a) and at least a first cation and a first anion shell precursor, optionally in a solvent, to form a shell layer onto the core, preferably said first cation shell precursor is a salt of an element of the group 12 of the periodic table and the first anion shell precursor is a source of an element of the group 16 of the periodic table to form a shell layer onto the core, wherein the molar ratio of total shell precursors used in step (b) and total core precursors used in step (a) is 6 or more, preferably in the range from 7 to 30, more preferably 8 to 30, even more preferably 9 to 27.

In another aspect, the present invention further relates to semiconducting light emitting nanoparticle obtainable or obtained from the process.

In another aspect, the present invention also relates to composition comprising or consisting of the semiconducting light emitting nanoparticle, and at least one additional material, preferably the additional material is selected from the group consisting of organic light emitting materials, inorganic light emitting materials, charge transporting materials, scattering particles, and matrix materials, preferably the matrix materials are optically transparent polymers.

In another aspect, the present invention relates to formulation comprising or consisting of the semiconducting light emitting nanoparticle or the composition, and at least one solvent, preferably the solvent is selected from one or more members of the group consisting of aromatic, halogenated and aliphatic hydrocarbon solvents, more preferably selected from one or more members of the group consisting of toluene, xylene, ethers, tetrahydrofuran, chloroform, dichloromethane and heptane, purified water, ester acetates, alcohols, sulfoxides, formamides, nitrides, ketones. In another aspect, the present invention relates to use of the semiconducting light emitting nanoparticle, or the composition, or the formulation in an electronic device, optical device or in a biomedical device.

In another aspect, the present invention related to use of the semiconducting light emitting nanoparticle, or the composition, or the formulation, in an electronic device, optical device or in a biomedical device.

In another aspect, the present invention further relates to an optical medium comprising said semiconducting light emitting nanoparticle, or the composition.

In another aspect, the present invention further relates to an optical device comprising said optical medium.

### DESCRIPTION OF DRAWINGS

FIG. 1: shows the photoluminescence spectra and the optical density of the sample obtained in working example 1.

FIG. 2: shows the photoluminescence spectra and the optical density of the sample obtained in comparative example 1.

FIG. 3: shows the photoluminescence spectra and the optical density of the sample obtained in working example 3.

FIG. 4: shows the photoluminescence spectra and the optical density of the sample obtained in comparative example 2.

FIG. 5: shows the photoluminescence spectra and the optical density of the sample obtained in working example 4.

FIG. 6: shows the photoluminescence spectra and the optical density of the sample obtained in comparative example 3.

### DETAILED DESCRIPTION OF THE INVENTION

### Semiconducting Light Emitting Nanoparticle

According to the present invention, said semiconducting light emitting nanoparticle comprising a core and at least one shell layer, wherein the semiconducting light emitting nanoparticle has the self-absorption value 0.35 or less, preferably, in the range from 0.30 to 0.01, more preferably, from 0.25 to 0.05, even more preferably, from 0.23 to 0.12.

### Self-Absorption Value Calculation

According to the present invention, the optical density (hereafter “OD”) of the nanoparticles is measured using Shimadzu UV-1800, double beam spectrophotometer, using toluene baseline, in the range between 350 and 800 nm.

The photoluminescence spectra (hereafter “PL”) of the nanoparticles is measured using Jasco FP fluorimeter, in the range between 460 and 800 nm, using 450 nm excitation.

The OD(λ) and PL (λ) are the measured optical density and the photoluminescence at wavelength of λ.

OD₁ represented by the formula (III) is the optical density normalized to the optical density at 450 nm, and α₁ represented by formula (IV) is the absorption corresponding to the normalized optical density.

$$\begin{matrix}{OD}_{1} = \frac{OD ( λ )}{OD ( λ = 450 nm )} & ( III ) \\ {a}_{1} = 1 - {10}^{- {OD}_{1}} & ( IV ) \\ SA = \frac{{\int }_{0}^{∞} PL ( λ ) {a}_{1} ( λ ) d λ}{{\int }_{0}^{∞} {PL}_{1} ( λ ) d λ} & ( V )\end{matrix}$$

The self-absorption value of the nanoparticles represented by formula (V) is calculated based on the OD and PL measurement raw data.

According to the present invention, it is believed that that lower-self absorbance of the nanoparticles is expected to prevent the QY decrease in high emitter concentrations.

According to the present invention, the term “semiconductor” means a material that has electrical conductivity to a degree between that of a conductor (such as copper) and that of an insulator (such as glass) at room temperature. Preferably, a semiconductor is a material whose electrical conductivity increases with the temperature.

The term “nanosized” means the size in between 0.1 nm and 999 nm, preferably 1 nm to 150 nm, more preferably 3 nm to 50 nm.

Thus, according to the present invention, “semiconducting light emitting nanoparticle” is taken to mean that the light emitting material which size is in between 0.1 nm and 999 nm, preferably 1 nm to 150 nm, more preferably 3 nm to 50 nm, having electrical conductivity to a degree between that of a conductor (such as copper) and that of an insulator (such as glass) at room temperature, preferably, a semiconductor is a material whose electrical conductivity increases with the temperature, and the size is in between 0.1 nm and 999 nm, preferably 0.5 nm to 150 nm, more preferably 1 nm to 50 nm.

According to the present invention, the term “size” means the average diameter of the longest axis of the semiconducting nanosized light emitting particles.

The average diameter of the semiconducting nanosized light emitting particles are calculated based on 100 semiconducting light emitting nanoparticles in a TEM image created by a Tecnai G2 Spirit Twin T-12 Transmission Electron Microscope.

In a preferred embodiment of the present invention, the semiconducting light emitting nanoparticle of the present invention is a quantum sized material.

According to the present invention, the term “quantum sized” means the size of the semiconducting material itself without ligands or another surface modification, which can show the quantum confinement effect, like described in, for example, ISBN:978-3-662-44822-9.

Generally, it is said that the quantum sized materials can emit tunable, sharp and vivid colored light due to “quantum confinement” effect.

In some embodiments of the invention, the size of the overall structures of the quantum sized material, is from 1 nm to 50 nm, more preferably, it is from 1 nm to 30 nm, even more preferably, it is from 5 nm to 15 nm. According to the present invention, said core of the semiconducting light emitting nanoparticle can be varied.

For example, CdS, CdSe, CdTe, ZnS, ZnSe, ZnSeS, ZnTe, ZnO, GaAs, GaP, GaSb, HgS, HgSe, HgSe, HgTe, InAs, InP, InPS, InPZnS, InPZn, InPZnSe, InCdP, InPCdS, InPCdSe, InGaP, InGaPZn, InSb, AlAs, AlP, AlSb, Cu₂S, Cu₂Se, CuInS2, CuInSe₂, Cu₂(ZnSn)S₄, Cu₂(InGa)S₄, TiO₂ alloys and a combination of any of these can be used.

In a preferred embodiment of the present invention, the core comprises one element of the group 13 of the periodic table, and one element of the group 15 of the periodic table, preferably the element of the group 13 is In, and the element of the group 15 is P, more preferably the core is represented by the following formula (I), or formula (I′).

In₁₋ₓGaₓZn_{z}P (I)

wherein 0≤x≤1, 0≤z≤1, even more preferably the core is InP, InxZn_{z}P, or In₁₋ₓGaₓP.

A person skilled in the art can easily understand that there is a counter ion in or around the core and thus, the chemical formula (I) is electrically neutral.

In_{1-x-2/3z}GaₓZn_{z}P (I′)

wherein 0≤x≤1, 0≤z≤1, even more preferably the core is InP, In_{1-2/3z}Zn_{z}P, or In₁₋ₓGaₓP.

In case of In_{1-2/3z}Zn_{z}P, x is 0, and 0<z≤1. And Zn atom can be directly onto the surface of the core or alloyed with InP. The ratio between Zn and In is in the range between 0.05 and 5. Preferably, between 0.07 and 1.

According to the present invention, a type of shape of the core of the semiconducting light emitting nanoparticle, and shape of the semiconducting light emitting nanoparticle to be synthesized are not particularly limited.

For examples, spherical shaped, elongated shaped, star shaped, polyhedron shaped, pyramidal shaped, tetrapod shaped, tetrahedron shaped, platelet shaped, cone shaped, and irregular shaped core and—or a semiconducting light emitting nanoparticle can be synthesized.

In some embodiments of the present invention, the average diameter of the core is in the range from 1.5 nm to 3.5 nm.

In some embodiments of the present invention, the shell layer comprises or is consisting of a 1^{st} element of group 12 of the periodic table and a 2^{nd} element of group 16 of the periodic table, preferably, the 1^{st} element is Zn, and the 2^{nd} element is S, Se, or Te.

In a preferred embodiment of the present invention, the shell layer is represented by following formula (II),

ZnSₓSe_{y}Te_{z}, (II)

wherein 0≤x≤1, 0≤y≤1, 0≤z≤1, and x+y+z=1, preferably, the shell layer is ZnSe, ZnSₓSe_{y}, ZnSe_{y}Te_{z} or ZnSₓTe_{z}.

In some embodiments of the present invention, said shell layer is an alloyed shell layer or a graded shell layer preferably said graded shell layer is ZnSₓSe_{y}, ZnSe_{y}Te_{z}, or ZnSₓTe_{z}, more preferably it is ZnSₓSe_{y}.

The ratio of y/x is preferably larger than 0.5, more preferably larger than 1 and even more preferably larger than 2.

The ratio of y/z is preferably larger than 1 and more preferably larger than 2, and even more preferably larger than 4.

In some embodiments of the present invention, the semiconducting light emitting nanoparticle further comprises a 2^{nd} shell layer onto said shell layer, preferably the 2^{nd} shell layer comprises or a consisting of a 3^{rd} element of group 12 of the periodic table and a 4^{th} element of group 16 of the periodic table, more preferably the 3^{rd} element is Zn, and the 4^{th} element is S, Se, or Te with the proviso that the 4^{th} element and the 2^{nd} element are not the same.

In a preferred embodiment of the present invention, the 2^{nd} shell layer is represented by following formula (II″),

ZnSₓSe_{y}Te_{z}, (II″)

wherein the formula (II″), 0≤x≤1, 0≤y≤1, 0≤z≤1, and x+y+z=1, preferably, the shell layer is ZnSe, ZnSₓSe_{y}, ZnSe_{y}Te_{z}, or ZnSₓTe_{z} with the proviso that the shell layer and the 2^{nd} shell layer is not the same.

In some embodiments of the present invention, said 2^{nd} shell layer can be an alloyed shell layer or a graded shell layer, preferably said graded shell layer is ZnSₓSe_{y}, ZnSe_{y}Te_{z}, or ZnSₓTe_{z}, more preferably it is ZnSₓSe_{y}.

In some embodiments of the present invention, the semiconducting light emitting nanoparticle can further comprise one or more additional shell layers onto the 2^{nd} shell layer as a multishell.

According to the present invention, the term “multishells” stands for the stacked shell layers consisting of three or more shell layers.

For example, CdSe/CdS, CdSeS/CdZnS, CdSeS/CdS/ZnS, ZnSe/CdS, CdSe/ZnS, InP/ZnS, InP/ZnSe, InP/ZnSe/ZnS, InZnP/ZnS, InZnP/ZnSe, InZnP/ZnSe/ZnS, InGaP/ZnS, InGaP/ZnSe, InGaP/ZnSe/ZnS, InZnPS/ZnS, InZnPS ZnSe, InZnPS/ZnSe/ZnS, ZnSe/CdS, ZnSe/ZnS or combination of any of these, can be used. Preferably, InP/ZnS, InP/ZnSe, InP/ZnSeₓS₁₋ₓ, InP/ZnSeₓS₁₋ₓ/ZnS, InP/ZnSe/ZnS, InZnP/ZnS, InP/ZnSeₓTe₁₋ₓ/ZnS, InP/ZnSeₓTe₁₋ₓ, InZnP/ZnSe, InZnP/ZnSe/ZnS, InGaP/ZnS, InGaP/ZnSe, InGaP/ZnSe/ZnS.

In some embodiments of the present invention, the volume ratio between the shell and the core of the semiconducting light emitting nanoparticle is 5 or more, preferably, it is in the range from 5 to 40, more preferably it is from 10 to 30.

According to the present invention, said shell/core ratio is calculated using following formula (VI).

$$\frac{Vshell}{Vcore} = ( \frac{The element of the group 12}{The element of the group 13} ) \cdot \frac{\frac{Mw ( Total shell elements )}{ρ ( Total shell elements )}}{\frac{Mw ( Total core elements )}{ρ ( Total core elements )}} \qquad ( VI )$$

### Elemental Analysis

According to the present invention, the following elemental analysis is used in order to determine the molar ratio between group 12 element and group 13 element.

The semiconducting light emitting nanoparticle is dissolved in toluene and the obtained solution is diluted. One droplet of the diluted solution is dripped on a Cu/C TEM grid with ultrathin amorphous carbon layer. The grid is dried in vacuum at 80° C. for 1.5 hours to remove the residues of the solvent as well as possible organic residues.

EDS measurements are carried out in STEM mode using high resolution TEM—a Tecnai F20 G2 machine operating at 200 kV equipped with EDAX Energy Dispersive X-Ray Spectrometer. TIA software is used for spectra acquisition and calculations and no standards are used.

The atomic ratio of the element of the group 12 and the element of the group 13 of the periodic table is used for the shell/core ratio calculation.

For examples, in case the semiconducting light emitting nanoparticle is InP/ZnSe, the calculation is carried out as follows,

$$\frac{Vshell}{Vcore} = ( \frac{Zn}{In} ) \cdot \frac{\frac{Mw ( ZnSe )}{ρ ( ZnSe}}{\frac{Mw ( InP )}{ρ ( InP )}}$$

In some embodiments of the present invention, the surface of the semiconducting light emitting nanoparticle can be over coated with one or more kinds of surface ligands.

Without wishing to be bound by theory it is believed that such a surface ligands may lead to disperse the nanosized fluorescent material in a solvent more easily.

The surface ligands in common use include phosphines and phosphine oxides such as Trioctylphosphine oxide (TOPO), Trioctylphosphine (TOP), and Tributylphosphine (TBP); phosphonic acids such as Dodecylphosphonic acid (DDPA), Tridecylphosphonic acid (TDPA), amines such as Oleylamine, Dedecyl amine (DDA), Tetradecyl amine (TDA), Hexadecyl amine (HDA), and Octadecyl amine (ODA), Oleylamine (OLA), 1-Octadecene (ODE), thiols such as hexadecane thiol and hexane thiol; mercapto carboxylic acids such as mercapto propionic acid and mercaptoundecanoicacid; carboxylic acids such as oleic acid, stearic acid, myristic acid; acetic acid and a combination of any of these. Furthermore the ligands can include Zn-oleate, Zn-acetate, Zn-myristate, Zn-Stearate, Zn-laurate and other Zn-carboxylates. And also. Polyethylenimine (PEI) also can be used preferably.

Examples of surface ligands have been described in, for example, the laid-open international patent application No. WO 2012/059931A.

### Process

In another aspect, the present invention also relates to a process for synthesizing the semiconducting light emitting nanoparticle comprising following steps (a) and (b),

(a) preparing a core by providing at least a first and a second core precursor optionally in a solvent, preferably said first core precursor is a salt of the element of the group 12 or of the group 13 and said second core precursor is a source of an element of the group 15 of the periodic table, more preferably the element of the group 13 is In, Ga or a mixture of thereof, the element of the group 12 is Cd, Zn or mixture of thereof, and the element of the group 15 is P, or As, even more preferably said first core precursor is a salt of the element of the group 13 selected from In or Ga or a mixture of thereof,
(b) providing the core obtained in the step (a) and at least a first cation and a first anion shell precursor, optionally in a solvent, to form a shell layer onto the core, preferably said first cation shell precursor is a salt of an element of the group 12 of the periodic table and the first anion shell precursor is a source of an element of the group 16 of the periodic table to form a shell layer onto the core, wherein the molar ratio of total shell precursors used in step (b) and total core precursors used in step (a) is 6 or more, preferably in the range from 7 to 30, more preferably 8 to 30, even more preferably 9 to 27, to realize better core/shell ratio and lower self-absorption value of the semiconducting light emitting nanoparticle.

In a preferred embodiment of the present invention, said shell is formed at temperature in the range from 280° C. to 350° C., more preferably from 300° C. to 340° C.

### Step (a)

Even more preferably, said first core precursor is a salt of the element of the group 13 of the periodic table selected from In and/or Ga, and said chemical element in group 15 of the periodic table is As, P, or Sb.

In some embodiments of the present invention, the core further comprises a chemical element in group 12 of the periodic table selected from Zn or Cd.

Furthermore preferably, the core which is prepared in step (a), is selected from the group consisting of InP, InZnP, InGaP, InGaZnP, InPZnS, InPZnSe, InCdP, InPCdS, InPCdSe, InAs, InSb, AlAs, AlP, and AlSb.

Further more preferably, the core obtained in step (a) is InP or InZnP. Zn atom can be directly onto the surface of the core or alloyed with InP. The ratio between Zn and In is in the range between 0.05 and 5. Preferably, between 0.3 and 1.

In some embodiments of the present invention, the InP based core such as InP, InZnP, InGaP, InGaZnP, InPZnS, or InPZnSe, can be prepared by using an amino phosphine as an anion precursor represented by following chemical formula (VII), and an Metal-halide precursor as a cation precursor represented by following chemical formula (VIII).

(R¹R²N)₃P (VII)

wherein R¹ and R² are at each occurrence, independently or dependently, a hydrogen atom or an alkyl or alkene chain having 1 to 25 carbon atoms.

MX²₃ (VIII)

wherein M is In or Ga, X² is a halogen selected from the group consisting of Cl, Br and I.

In a preferred embodiment of the present invention, one or more of metal halides represented by chemical formula (VIII) is used in step (a) to prepare the core.

### Solvent

In some embodiment of the present invention, the solvent in step (a) and/or (b) can be a solvent selected from one or more members of the group consisting of squalenes, squalanes, heptadecanes, octadecanes, octadecenes, nonadecanes, icosanes, henicosanes, docosanes, tricosanes, pentacosanes, hexacosanes, octacosanes, nonacosanes, triacontanes, hentriacontanes, dotriacontanes, tritriacontanes, tetratriacontanes, pentatriacontanes, hexatriacontanes, oleylamines, and trioctylamines.

In some embodiments, alkyl chain lengths of said solvent can be C1 to C30, and the chain can be linear or branched.

According to the present invention, as a solvent, an organic solvent represented by following chemical formula (VIII) can be used in step (a) preferably.

ZR³R⁴R⁵ (IX)

wherein the formula, R³ is a hydrogen atom or an alkyl or alkene chain having 1 to 20 carbon atoms, R⁴ is a hydrogen atom or an alkyl or alkyne chain having 1 to 20 carbon atoms, R⁵ is an alkyne chain having 2 to 20 carbon atoms, Z is N, or P.

In a preferred embodiment of the present invention, Z is N.

More preferably, R³ and R⁴ are hydrogen atoms and R⁵ is an alkyne chain having 2 to 20 carbon atoms, and Z is N.

Even more preferably, the organic solvent represented by chemical formula (IX) is oleylamine.

In other words, to the surface of the core in step (a) is attached at least one ligand that is described by the chemical formula (XI).

In some embodiments of the present invention, at least one ligand represented by chemical formula (IX), and a halide ion delivered from the In-halide or Zn-halide precursor represented by chemical formula (VIII) are attached onto the surface of the core.

### Step (b)

### Cation Precursors for Shell Layer Coating Step (b)

According to the present invention, as a cation precursor for step (b), one or more of known cation precursors for shell layer synthesis comprising group 12 element of the periodic table or 13 element of the periodic table can be used preferably.

For example, as a first and a second cation shell precursor, one or more members of the group consisting of Zn-oleate, Zn-carboxylate, Zn-acetate, Zn-myristate, Zn-stearate, Zn-undecylenate, Zn-acetate-alkylamine complexes, Zn-phosphonate, ZnCl₂, ZnI₂, ZnBr₂, Zn-palmitate, Cd-oleate, Cd-carboxylate, Cd-acetate, Cd-myristate, Cd-stearate and Cd-undecylenate, Cd-phosphonate, CdCl₂, Ga-oleate, Ga-carboxylate, Ga-acetate, Ga-myristate, Ga-stearate, Ga-undecylenate, Ga-acetlyacetanote can be used, More preferably, one or more members of the group consisting of Zn-oleate, Zn-carboxylate, Zn-acetate, Zn-myristate, Zn-stearate, Zn-undecylenate and Zn-acetate-oleylamine complexes are used to coat said shell layer(s) onto the core.

Even more preferably, Zn-oleate is used as a first cation precursor for shell layer coating step (b).

In some embodiment of the present invention, the metal halides represented by chemical formula (X) also can be used as one of the cation precursors instead of the cation precursors indicated above or in addition to the cation precursors indicated above.

M¹X¹ₙ (X)

wherein M¹ is Zn or Cd, X¹ is a halogen selected from the group consisting of Cl, Br and I, n is 2.

In some embodiments, the metal halides and the cation precursor can be mixed, or, the metal halide can be used as a single cation precursor instead of the cation precursor which is mentioned in the column of cation precursors for shell layer coating step, if necessary.

### Anion Precursors for Shell Layer Coating

According to the present invention, as an anion shell precursor for shell layer coating, known anion precursor for shell layer synthesis comprising a group 16 element of the periodic table can be used preferably.

For example, as a first and a second anion precursor for shell layer coating can be selected from one or more members of the group consisting of Se anion: Se, Se-trioctylphopshine, Se-tributylphosphine, Se-oleylamine complex, Selenourea, Se-octadecene complex, Se-octadecene suspension, S anion and thiols such as octanethiol, dodecanthiol, ter-doedecanthiol, S,S-trioctylphopshine, S-tributylphosphine, S-oleylamine complex, Selenourea, S-octadecene complex, and S-octadecene suspension, Te anion: Te, Te-trioctylphopshine, Te-tributylphosphine, Te-oleylamine complex, Telenourea, Te-octadecene complex, and Te-octadecene suspension.

In some embodiments of the present invention, at least said first anion shell precursor and a second anion shell precursor are added simultaneously in step (b), preferably said first anion shell precursor is selected from the group consisting of Se anion: Se, Se-trioctylphopshine, Se-tributylphosphine, Se-oleylamine complex, Selenourea, Se-octadecene complex, and Se-octadecene suspension, and the second anion shell precursor is selected from the group consisting of S anion: S, S-trioctylphopshine, S-tributylphosphine, S-oleylamine complex, Selenourea, S-octadecene complex, and S-octadecene suspension, Te anion: Te, Te-trioctylphopshine, Te-tributylphosphine, Te-oleylamine complex, Telenourea, Te-octadecene complex, and Te-octadecene suspension. Without wishing to be bound to the theory, it is believed that the addition of said first anion shell precursor and a second anion shell precursor may lead graded shell due to the reason that the reaction speed of Se anion and the reaction speed of S or Te are different of each other.

In some embodiments of the present invention, at least said first anion shell precursor and a second anion shell precursor are added sequentially in step (b), preferably said first anion shell precursor is selected from the group consisting of Se anion: Se, Se-trioctylphopshine, Se-tributylphosphine, Se-oleylamine complex, Selenourea, Se-octadecene complex, and Se-octadecene suspension, and the second anion shell precursor is selected from the group consisting of S anion: S, S-trioctylphopshine, S-tributylphosphine, S-oleylamine complex, Selenourea, S-octadecene complex, and S-octadecene suspension, Te anion: Te, Te-trioctylphopshine, Te-tributylphosphine, Te-oleylamine complex, Telenourea, Te-octadecene complex, and Te-octadecene suspension.

By changing the reaction temperature in step (b), and total amount of precursors used in step (b), the volume ratio between the core and the shell is more preferably controlled.

In a preferred embodiment of the present invention, step (b) is carried out at 250° C. or more, preferably, it is in the range from 250° C. to 350° C., more preferably, from 280° C. to 320° C. to realize better shell/core volume ratio and lower self-absorption value of the semiconducting light emitting nanoparticle.

Other conditions for shell coating step (b) are described for example in U.S. Pat. No. 8,679,543 B2 and Chem. Mater. 2015, 27, pp 4893-4898.

It is believed that this process can also control the crystallinity of the shell layer. For example, it is believed that highly crystalline ZnSe shell is obtained using this process.

### Solvent for Step (b)

In some embodiment of the present invention, as described in the section of “solvent”, a solvent selected from one or more members of the group consisting of squalenes, squalanes, heptadecanes, octadecanes, octadecenes, nonadecanes, icosanes, henicosanes, docosanes, tricosanes, pentacosanes, hexacosanes, octacosanes, nonacosanes, triacontanes, hentriacontanes, dotriacontanes, tritriacontanes, tetratriacontanes, pentatriacontanes, hexatriacontanes, oleylamines, and trioctylamines, preferably squalene, squalane, heptadecane, octadecane, octadecene, nonadecane, icosane, henicosane, docosane, tricosane, pentacosane, hexacosane, octacosane, nonacosane, triacontane, hentriacontane, dotriacontane, tritriacontane, tetratriacontane, pentatriacontane, hexatriacontane, oleylamine, and trioctylamine, more preferably squalane, pentacosane, hexacosane, octacosane, nonacosane, triacontane, octadecene or oleylamine can be used preferably in step (b).

In some embodiments, alkyl chain lengths of said solvent can be C1 to C25, and the chain can be linear or branched.

In some embodiment of the present invention, the step (a) and step (b) can be carried out in the same vessel continiouslly or in a separated different vessel.

### Step (c)

In some embodiment of the present invention, the process further comprises following step (c) after step (a) and before step (b), (c) making a mixture solution by mixing the obtained solution from step (a) and a cleaning solution of the present invention, to make a suspension in the mixture solution and to separate unreacted core precursors and ligands from the suspension.

In a preferred embodiment of the present invention, the step (c) further comprises following step (C1),

(C1) extracting the suspension and dispersing it in a solvent, preferably centrifuging the suspension to extract the suspension and dispersing the centrifuged suspension in a solvent.

In a preferred embodiment of the invention, the solvent in step (C1) is selected from the solvent described in the section of “Solvent” above.

### Cleaning Solution

In some embodiments of the present invention, the cleaning solution for step (c) comprises at least one solvent selected from one or more members of the group consisting of ketones, such as, methyl ethyl ketone, acetone, methyl amyl ketone, methyl isobutyl ketone, and cyclohexanone; alcohols, such as, methanol, ethanol, propanol, butanol, hexanol, cyclo hexanol, ethylene glycol; hexane; chloroform; acetonitrile; xylene and toluene.

In a preferred embodiment of the present invention, the cleaning solution is selected from one or more members of the group consisting of ketones, such as, methyl ethyl ketone, acetone, methyl amyl ketone, methyl isobutyl ketone, and cyclohexanone; alcohols, such as, methanol, ethanol, propanol, butanol, hexanol, cyclo hexanol, ethylene glycol; hexane; chloroform; xylene and toluene.

In a preferred embodiment of the present invention, to more effectively remove unreacted core precursors from the solution obtained in step (a) and remove the ligands leftovers in the solution, cleaning solution comprises one or more of alcohols is used.

More preferably, the cleaning solution contains one or more of alcohols selected from the group consisting of acetonitrile, methanol, ethanol, propanol, butanol, and hexanol, and one more solution selected from xylene or toluene to remove unreacted core precursors from the solution obtained in step (a) and remove the ligands leftovers in the solution effectively.

More preferably, the cleaning solution contains one or more of alcohols selected from methanol, ethanol, propanol, and butanol, and toluene.

In some embodiments of the present invention, the mixing ratio of alcohols and toluene or xylene can be in the range from 1:1-20:1 in a molar ratio. Preferably it is from 5:1 to 10:1, to remove unreacted core precursors from the solution obtained in step (a) and to remove the ligands leftovers in the solution.

More preferably, the cleaning solution removes the extra ligands and the unreacted precursor.

In a preferred embodiment of the present invention, the process further comprises step (d) before step (b) after step (c).

(d) adding at least one additive selected from the group consisting of metal halides represented by following chemical formula (I) and amino phosphine represented by following chemical formula (II),

M₁X¹ₙ (I)

wherein M¹ is Zn or Cd, X¹ is a halogen selected from the group consisting of Cl, Br and I, n is 2.

(R¹R²N)₃P (II)

wherein R¹ and R² are at each occurrence, independently or dependently, a hydrogen atom or an alkyl or alkene chain having 1 to 25 carbon atoms.

In a preferred embodiment of the present invention, step (a), (b), and optionally step (c) and/or (d) are carried out in an inert condition, such as N₂ atmosphere.

More preferably, all the steps (a), (b) and optionally step (c) and (d) are carried out in said inert condition.

### Semiconducting Light Emitting Nanoparticle

In another aspect, the present invention also relates to a semiconducting light emitting nanoparticle obtainable or obtained from the process of the present invention.

Thus, the present invention relates to a semiconducting light emitting nanoparticle obtainable or obtained from the process comprising following steps (a) and (b),

(a) preparing a core by providing at least a first and a second core precursor optionally in a solvent, preferably said first core precursor is a salt of the element of the group 12 or of the group 13 and said second core precursor is a source of an element of the group 15 of the periodic table, more preferably the element of the group 13 is In, Ga or a mixture of thereof, the element of the group 12 is Cd, Zn or mixture of thereof, and the element of the group 15 is P, or As, even more preferably said first core precursor is a salt of the element of the group 13 selected from In or Ga or a mixture of thereof,
(b) providing the core obtained in the step (a) and at least first cation and first anion shell precursor, optionally in a solvent, to form a shell layer onto the core, preferably said first cation shell precursor is a salt of an element of the group 12 of the periodic table and the first anion shell precursor is a source of an element of the group 16 of the periodic table to form a shell layer onto the core, wherein the molar ratio of total shell precursors used in step (b) and total core precursors used in step (a) is 6 or more, preferably in the range from 7 to 30, more preferably 8 to 30, even more preferably 9 to 27.

More details of the said process are described in the section of “Process”.

### Composition

In another aspect, the present invention also relates to composition comprising or consisting of the semiconducting light emitting nanoparticle, and at least one additional material, preferably the additional material is selected from the group consisting of organic light emitting materials, inorganic light emitting materials, charge transporting materials, scattering particles, and matrix materials, preferably the matrix materials are optically transparent polymers.

For example, said activator can be selected from the group consisting of Sc³⁺, Y³⁺, La³⁺, Ce³⁺, Pr³⁺, Nd³⁺, Pm³⁺, Sm³⁺, Eu³⁺, Gd³⁺, Tb³⁺, Dy³⁺, Ho³⁺, Er³⁺, Tm³⁺, Yb³⁺, Lu³⁺, Bi³⁺, Pb²⁺, Mn²⁺, Yb²⁺, Sm²⁺, Eu²⁺, Dy²⁺, Ho²⁺ and a combination of any of these, and said inorganic fluorescent material can be selected from the group consisting of sulfides, thiogallates, nitrides, oxynitrides, silicate, aluminates, apatites, borates, oxides, phosphates, halophosphates, sulfates, tungstenates, tantalates, vanadates, molybdates, niobates, titanates, germinates, halides based phosphors, and a combination of any of these.

Such suitable inorganic fluorescent materials described above can be well known phosphors including nanosized phosphors, quantum sized materials like mentioned in the phosphor handbook, 2^{nd} edition (CRC Press, 2006), pp. 155-pp. 338 (W. M. Yen, S. Shionoya and H. Yamamoto), WO2011/147517A, WO2012/034625A, and WO2010/095140A.

According to the present invention, as said organic light emitting materials, charge transporting materials, any type of publicly known materials can be used preferably. For example, well known organic fluorescent materials, organic host materials, organic dyes, organic electron transporting materials, organic metal complexes, and organic hole transporting materials.

For examples of scattering particles, small particles of inorganic oxides such as SiO₂, SnO₂, CuO, CoO, Al₂O₃, TiO₂, Fe₂O₃, Y₂O₃, ZnO, MgO; organic particles such as polymerized polystyrene, polymerized PMMA; inorganic hollow oxides such as hollow silica or a combination of any of these; can be used preferably.

### Matrix Material

According to the present invention, a wide variety of publicly known transparent matrix materials suitable for optical devices can be used preferably.

According to the present invention, the term “transparent” means at least around 60% of incident light transmit at the thickness used in an optical medium and at a wavelength or a range of wavelength used during operation of an optical medium. Preferably, it is over 70%, more preferably, over 75%, the most preferably, it is over 80%.

In a preferred embodiment of the present invention, as said matrix material, any type of publicly known transparent matrix material, described in for example, WO 2016/134820A can be used.

In some embodiments of the present invention, the transparent matrix material can be a transparent polymer.

According to the present invention the term “polymer” means a material having a repeating unit and having the weight average molecular weight (Mw) 1000 g/mol, or more.

The molecular weight M_{w} is determined by means of GPC (=gel permeation chromatography) against an internal polystyrene standard.

In some embodiments of the present invention, the glass transition temperature (Tg) of the transparent polymer is 70° C. or more and 250° C. or less.

Tg is measured based on changes in the heat capacity observed in Differential scanning colorimetry like described in http://pslc.ws/macrog/dsc.htm; Rickey J Seyler, Assignment of the Glass Transition, ASTM publication code number (PCN) 04-012490-50.

For example, as the transparent polymer for the transparent matrix material, poly(meth)acrylates, epoxys, polyurethanes, polysiloxanes, can be used preferably.

In a preferred embodiment of the present invention, the weight average molecular weight (Mw) of the polymer as the transparent matrix material is in the range from 1,000 to 300,000 g/mol, more preferably it is from 10,000 to 250,000 g/mol.

### Formulation

In another aspect, the present invention relates to formulation comprising or consisting of the semiconducting light emitting nanoparticle or the composition, and at least one solvent, preferably the solvent is selected from one or more members of the group consisting of aromatic, halogenated and aliphatic hydrocarbon solvents, more preferably selected from one or more members of the group consisting of toluene, xylene, ethers, tetrahydrofuran, chloroform, dichloromethane and heptane, purified water, ester acetates, alcohols, sulfoxides, formamides, nitrides, ketones.

The amount of the solvent in the formulation can be freely controlled according to the method of coating the composition. For example, if the composition is to be spray-coated, it can contain the solvent in an amount of 90 wt. % or more. Further, if a slit-coating method, which is often adopted in coating a large substrate, is to be carried out, the content of the solvent is normally 60 wt. % or more, preferably 70 wt. % or more.

### Use

In another aspect, the present invention related to use of the semiconducting light emitting nanoparticle, or the composition, or the formulation, in an electronic device, optical device or in a biomedical device.

### Optical Medium

In another aspect, the present invention further relates to an optical medium comprising said semiconducting light emitting nanoparticle, or the composition.

In some embodiments of the present invention, the optical medium can be an optical sheet, for example, a color filter, color conversion film, remote phosphor tape, or another film or filter.

According to the present invention, the term “sheet” includes film and/or layer like structured mediums.

### Optical Device

In another aspect, the invention further relates to an optical device comprising the optical medium.

In some embodiments of the present invention, the optical device can be a liquid crystal display device (LCD), Organic Light Emitting Diode (OLED), backlight unit for an optical display, Light Emitting Diode device (LED), Micro Electro Mechanical Systems (here in after “MEMS”), electro wetting display, or an electrophoretic display, a lighting device, and/or a solar cell.

In another aspect, the present invention also relates to a method for preparing a nanosized light emitting semiconductor material comprising a core/shell structure, wherein the method comprises following steps (c), (d) and (e) in this sequence.

(c) synthesis of a core in a solution,
(d) removing the extra ligands from the core
(e) coating the core with at least one shell layer using said solution obtained in step (d),
wherein said core comprises InP and Zn, and the thickness of the shell is 0.8 nm or more

In some embodiments of the present invention, said shell comprises group 12 and group 16 elements of the periodic table.

In a preferred embodiment, said shell is ZnSe

In a preferred embodiment of the present invention, the method further comprises step (f) before step (e) after step (d).

(f) adding at least one additive selected from the group consisting of metal halides represented by following chemical formula (I) and aminophosphine represented by following chemical formula (II),

M¹X¹n (I)

wherein M¹ is Zn or Cd, X¹ is a halogen selected from the group consisting of Cl, Br and I, n is 2.

(R¹R²N)₃P (II)

wherein R¹ and R² are at each occurrence, independently or dependently, a hydrogen atom or an alkyl or alkene chain having 1 to 25 carbon atoms.

Preferred embodiments of the present invention are specified in the following paragraphs:
1. A semiconducting light emitting nanoparticle comprising, essentially consisting of, or a consisting of a core and at least one shell layer, wherein the semiconducting light emitting nanoparticle has the self-absorption value 0.35 or less, preferably, in the range from 0.30 to 0.01, more preferably, from 0.25 to 0.05, even more preferably, from 0.23 to 0.12.
2. The nanoparticle according to paragraph 1, wherein the core comprises, essentially consisting of, or a consisting of one element of the group 13 of the periodic table, and one element of the group 15 of the periodic table, preferably the element of the group 13 is In, and the element of the group 15 is P, more preferably the core is represented by the following formula (I),

In₁₋ₓGaₓZn_{z}P (I)
wherein 0≤x≤1, 0≤z≤1, even more preferably the core is InP, InₓZn_{z}P, or In₁₋ₓGaₓP.
3. The nanoparticle according to paragraph 1 or 2, wherein the shell layer comprises or is consisting of a 1^{st} element of group 12 of the periodic table and a 2^{nd} element of group 16 of the periodic table, preferably, the 1^{st} element is Zn, and the 2^{nd} element is S, Se, or Te.
4. The nanoparticle according to any one of paragraphs 1 to 3, wherein the shell layer is represented by following formula (II),

ZnSₓSe_{y}Te_{z}, (II)

wherein, 0≤x≤1, 0≤y≤1, 0≤z≤1, and x+y+z=1, preferably, the shell layer is ZnSe, ZnSₓSe_{y}, ZnSe_{y}Te_{z}, or ZnSₓTe_{z}.
5. The nanoparticle according to one or more of paragraphs 1 to 4, wherein said shell layer is an alloyed shell layer or a graded shell layer, preferably said graded shell layer is ZnSₓSe_{y}, ZnSe_{y}Te_{z}, or ZnSₓTe_{z}, more preferably it is ZnSₓSe_{y}.
6. The nanoparticle according to any one of paragraphs 1 to 5, wherein the semiconducting light emitting nanoparticle further comprises a 2^{nd} shell layer onto said shell layer, preferably the 2^{nd} shell layer comprises or is consisting of a 3^{rd} element of group 12 of the periodic table and a 4^{th} element of group 16 of the periodic table, more preferably the 3^{rd} element is Zn, and the 4^{th} element is S, Se, or Te with the proviso that the 4^{th} element and the 2^{nd} element are not the same.
7. The nanoparticle according to any one of paragraphs 1 to 6, where the volume ratio between the shell and the core is 5 or more, preferably, it is in the range from 5 to 40, more preferably it is from 10 to 30.
8. A process for synthesizing the nanoparticle according to any one of paragraphs 1 to 7 comprising following steps (a) and (b),
   (a) preparing a core by providing at least a first and a second core precursor optionally in a solvent, preferably said first core precursor is a salt of the element of the group 12 or of the group 13 and said second core precursor is a source of an element of the group 15 of the periodic table, more preferably the element of the group 13 is In, Ga or a mixture of thereof, the element of the group 12 is Cd, Zn or mixture of thereof, and the element of the group 15 is P, or As, even more preferably said first core precursor is a salt of the element of the group 13 selected from In or Ga or a mixture of thereof,
   (b) providing the core obtained in the step (a) and at least a first cation and a first anion shell precursor, optionally in a solvent, to form a shell layer onto the core, preferably said first cation shell precursor is a salt of an element of the group 12 of the periodic table and the first anion shell precursor is a source of an element of the group 16 of the periodic table to form a shell layer onto the core, wherein the molar ratio of total shell precursors used in step (b) and total core precursors used in step (a) is 6 or more, preferably in the range from 7 to 30, more preferably 8 to 30, even more preferably 9 to 27.
9. The process according to paragraph 8, wherein step (b) is carried out at 250° C. or more, preferably, it is in the range from 250° C. to 350° C., more preferably, from 280° C. to 320° C.
10. The process according to paragraph 8 or 9, wherein at least said first anion shell precursor and a second anion shell precursor are added simultaneously in step (b).
11. The process according to paragraph 8 or 9, wherein at least said first anion shell precursor and a second anion shell precursor are added sequentially in step (b).
12. A semiconducting light emitting nanoparticle obtainable or obtained from the process according to any one of paragraphs 8 to 11.
13. A composition comprising or consisting of the semiconducting light emitting nanoparticle according to any one of paragraphs 1 to 7, 12, and at least one additional material, preferably the additional material is selected from the group consisting of organic light emitting materials, inorganic light emitting materials, charge transporting materials, scattering particles, and matrix materials, preferably the matrix materials are optically transparent polymers.
14. Formulation comprising or consisting of the semiconducting light emitting nanoparticle according to any one of paragraphs 1 to 7, 12 or the composition according to paragraph 13,
   and at least one solvent, preferably the solvent is selected from one or more members of the group consisting of aromatic, halogenated and aliphatic hydrocarbon solvents, more preferably selected from one or more members of the group consisting of toluene, xylene, ethers, tetrahydrofuran, chloroform, dichloromethane and heptane, purified water, ester acetates, alcohols, sulfoxides, formamides, nitrides, ketones.
15. Use of the semiconducting light emitting nanoparticle according to any one of paragraphs 1 to 7, 12, or the composition according to paragraph 13, or the formulation according to paragraph 14 in an electronic device, optical device or in a biomedical device.
16. An optical medium comprising said semiconducting light emitting nanoparticle according to any one of paragraphs 1 to 7, 12, or the composition according to claim 13.
17. An optical device comprising said optical medium according to paragraph 16.

### Effect of the Invention

The present invention provides:
1. a novel semiconducting light emitting nanoparticle comprising a core and at least one shell layer with lower self-absorption value,
2. a novel semiconducting light emitting nanoparticle comprising a core and at least one shell layer with improved volume ratio between the core and the shell of the semiconducting light emitting nanoparticle,
3. a novel semiconducting light emitting nanoparticle comprising a core and at least one shell layer with better Quantum Yield,
4. a novel process for synthesizing a semiconducting light emitting nanoparticle comprising a core and at least one shell layer, which can more precisely control the volume ratio between the core and the shell of the semiconducting light emitting nanoparticle,
5. a novel process for synthesizing a semiconducting light emitting nanoparticle comprising a core and at least one shell layer, which can also control the crystallinity of the shell,
6. a novel semiconducting light emitting nanoparticle comprising a core and at least one highly crystalline shell layer.

The working examples 1-6 below provide descriptions of the present invention, as well as an in detail description of their fabrication.

### WORKING EXAMPLES

### Working Example 1: Fabrication of a Semiconducting Light Emitting Nanoparticle

### Core Synthesis

1 g of InCl₃, 3 g of ZnCl₂ and 50 mL of oleylamine are placed in a flask and degassed. Then the temperature of the flask is raised to 190° C.

At 190° C., 4.5 mL of tris-diethylaminophosphine is injected to the flask and it is kept at 190° C. for 26 minutes.

### Core Cleaning

The cores are then cleaned with toluene and ethanol. The process is repeated 2 times and then, half of the cores are taken to the shell synthesis and dissolved in 25 mL of oleylamine to get a core solution.

### Shell Synthesis

The cation and anion shell precursor used are (2M Trioctylphosphine (TOP):Se) as the anion shell precursor, prepared by mixing at room temperature, and Zn-acetate oleylamine precursor as the cation shell precursor, with Zn:oleylamine ratio of 1:2, mixed in Octadecene (hereafter ODE) with 0.4M concentration at 100° C. under argon.

Then the core solution is transferred to a flask.

Then, 1.5 g of cation precursor (ZnCl₂) and 5.5 mL of anion precursor (2M Trioctylphosphine (TOP): Se) are added in the core solution in the flask slowly.

The solution is then heated by steps, followed by successive injections of another cation shell precursor (24 mL of 0.4M Zn(oleate) in Octadecene (hereafter ODE)) and anion shell precursor (3.8 mL of 2M TOP:Se) as described in table 1.

Finally, the obtained solution is cooled down to room temperature under inert conditions.

| | Time | | | | | | |
|---|---|---|---|---|---|---|---|
| | 30 | | | | | | |
| | min | 60 min | 90 min | 120 min | 150 min | 180 min | 240 min |
| Temp. | 180° | 200° C. | 220° C. | 240° C. | 280° C. | 320° C. | 320° C. |
| | C. | | | | | | |
| Injec- | | cation | anion | cation | anion | cation | end |
| tion | | | | | | | |

At the end of the synthesis, the flask is cooled to room temperature. And a sample is taken (sample 1) from the flask for a measurement of the optical density, photoluminescence spectra and a calculation of the self-absorption value of sample 1.

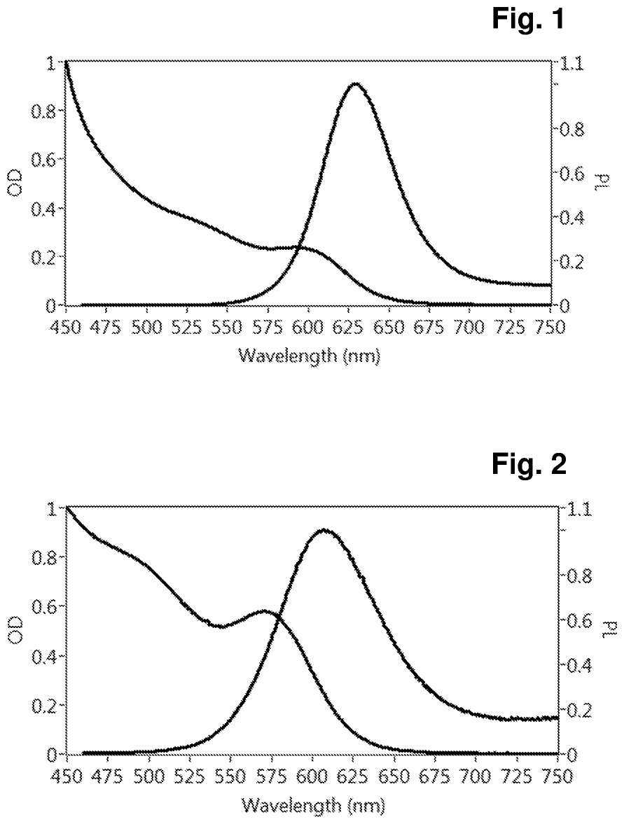

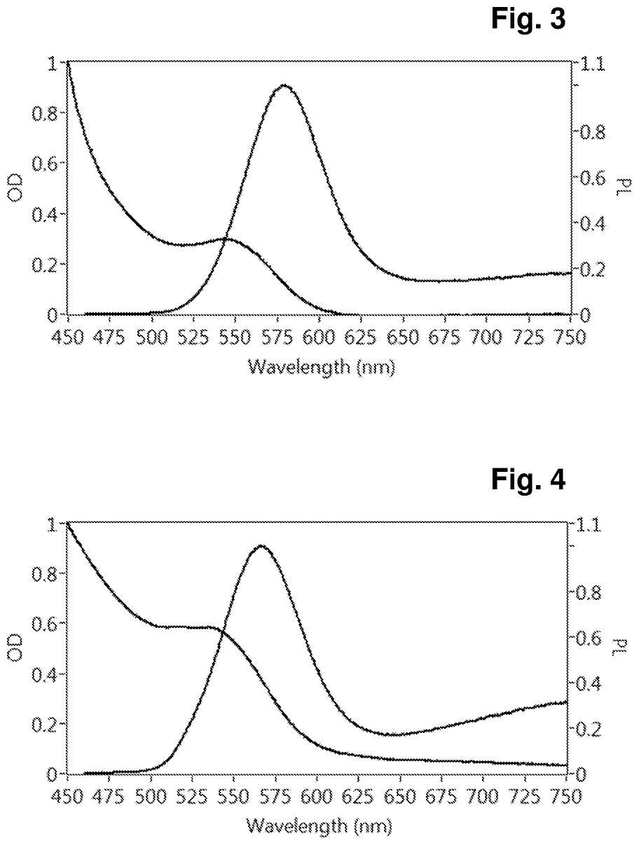

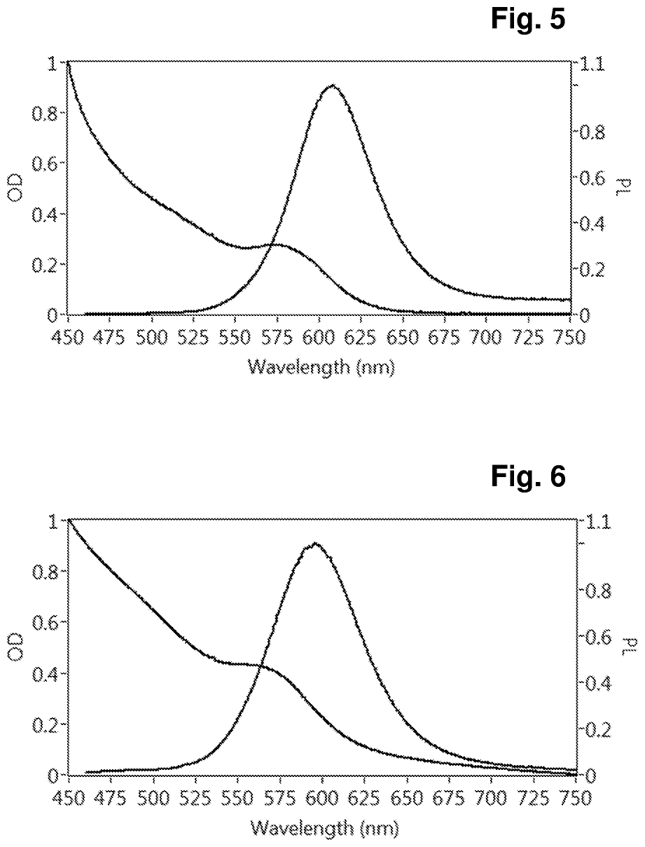

FIG. 1 shows the self-absorbance value of the sample 1 obtained in the working example 1.

### Comparative Example 1: Fabrication of a Semiconducting Light Emitting Nanoparticle

A semiconductor light emitting nanoparticles are synthesized in the same manner as described in working example 1, except for the reaction is terminated after 75 minutes. Then sample 2 is obtained.

### Working Example 2: Measurement of the Optical Density and the Photoluminescence Spectra and Calculation of the Self-Absorption Value

Optical density (hereafter “OD”) of the nanoparticles of sample 1 obtained in working example 1 and sample 2 obtained in comparative example are measured using Shimadzu UV-1800, double beam spectrophotometer, using toluene baseline, in the range between 350 and 800 nm.

The photoluminescence spectra (hereafter “PL”) of the nanoparticles of sample 1 and sample 2 are measured using Jasco FP fluorimeter, in the range between 460 and 800 nm, using 450 nm excitation.

### Self-Absorption Value Calculation

The self-absorption values of the nanoparticles of sample 1 and sample 2 represented by formula (V) are calculated in the same manner as described in the section of “Self-absorption value calculation” described above in page 5 and 6.

Table 1 show the results of the calculation.

TABLE 1

| Sample | Self-absorption value (SA) |
|---|---|
| Sample 1 | 0.20 |
| (Working example 1) | |
| Sample 2 | 0.34 |
| (Comparative example 1) | |

### Working Example 3: Fabrication of a Semiconducting Light Emitting Nanoparticle

A semiconductor light emitting nanoparticles are synthesized in the same manner as described in working example 1, except for that the core cleaning process is not carried out before shell synthesis and the shell precursors are injected into the same flask. Furthermore, Zn-stearate in ODE is used as the Zn-precursor, instead of Zn-acetate-oleylamine, mentioned in working example 1. Then sample 3 is obtained.

### Working Example 4: Fabrication of a Semiconducting Light Emitting Nanoparticle

A semiconductor light emitting nanoparticles are synthesized in the same manner as described in working example 3, except for that InI₃ is used as the In precursors, and Zn-oleate in ODE as the Zn-precursor. Then sample 4 is obtained.

### Comparative Example 2: Fabrication of a Semiconducting Light Emitting Nanoparticle

A semiconductor light emitting nanoparticles are synthesized in the same manner as described in working example 3, except for that the reaction is terminated after 210 minutes at 280° C. Then sample 5 is obtained.

### Comparative Example 3: Fabrication of a Semiconducting Light Emitting Nanoparticle

A semiconductor light emitting nanoparticles are synthesized in the same manner as described in working example 4, except for that the reaction is terminated after 210 minutes at 280° C. Then sample 6 is obtained.

### Working Example 5: Measurement of the Optical Density and the Photoluminescence Spectra and Calculation of the Self-Absorption Value

Optical density (hereafter “OD”) of the nanoparticles of sample 3 to 6 are measured using Shimadzu UV-1800, double beam spectrophotometer, using toluene baseline, in the range between 350 and 800 nm.

The photoluminescence spectra (hereafter “PL”) of the nanoparticles of sample 3 to 6 are measured using Jasco FP fluorimeter, in the range between 460 and 800 nm, using 450 nm excitation.

### Self-Absorption Value Calculation

The self-absorption values of the nanoparticles of samples 3 to 6 are caluculated in the same manner as described in working example 2

Table 2 show the results of the calculation.

TABLE 2

| Sample | Self-absorption value (SA) |
|---|---|
| Sample 3 | 0.15 |
| (Working example 3) | |
| Sample 4 | 0.23 |
| (Working example 4) | |
| Sample 5 | 0.35 |
| (Comparative example 2) | |
| Sample 6 | 0.41 |
| (Comparative example 3) | |

### Working Example 5: Fabrication of a Semiconducting Light Emitting Nanoparticle

### Core Synthesis

0.224 g of InI₃, 0.15 g of ZnCl₂ and 2.5 g of oleylamine are placed in a flask. Then the temperature of the flask is raised to 180° C.

At 180° C., 0.445 mL of tris-diethylaminophosphine is injected to the flask and it is kept at 180° C. for 20 minutes.

### Shell Synthesis

Then TOP:Se, TOP:S, and Zn-oleate in ODE are subsequently added as described below.

| Time (min) | Temperature (° C.) | Injected material |
|---|---|---|
| 20 | 180 | 1.15 mL TOP-Se |
| 120 | 200 | 4.8 mL Zn-oleate |
| 150 | 220 | 0.765 mL TOP-Se |
| 180 | 240 | 4.8 mL Zn-oleate |
| 210 | 280 | 0.591 mL TOP-Se + |
| | | 0.168 mL TOP-S |
| 240 | 320 | 4.1 mL Zn-oleate |
| 270 | 320 | 0.765 mL TOP-S |
| 300 | 320 | 1.2 mL Zn-oleate |

At the end of the synthesis, the flask is cooled to room temperature. And a sample is taken (sample 7) from the flask for a measurement of relative Quantum Yield (QY) value.

### Working Example 6: Fabrication of a Semiconducting Light Emitting Nanoparticle

### Core Synthesis

0.224 g of InI₃, 0.15 g of ZnCl₂ and 2.5 g of oleylamine are placed in a flask and degassed. Then the temperature of the flask is raised to 180° C.

At 180° C., 0.445 mL of tris-diethylaminophosphine is injected to the flask and it is kept at 180° C. for 20 minutes.

### Shell Synthesis

Then TOP:Se, TBP:S, and Zn-oleate in ODE are subsequently added as described below.

| Time (min) | Temperature (° C.) | Injected material |
|---|---|---|
| 20 | 180 | 1.15 mL TOP-Se |
| 120 | 200 | 4.8 mL Zn-oleate |
| 150 | 220 | 0.765 mL TOP-Se |
| 180 | 240 | 4.8 mL Zn-oleate |
| 210 | 280 | 0.591 mL TOP-Se + |
| | | 0.168 mL TBP-S |
| 240 | 320 | 4.1 mL Zn-oleate |
| 270 | 320 | 0.765 mL TBP-S |
| 300 | 320 | 1.2 mL Zn-oleate |

At the end of the synthesis, the flask is cooled to room temperature. And a sample is taken (sample 8) from the flask for the self-absorption value calculation.

### Self-Absorption Value Calculation

The self-absorption value calculation of samples 7 and 8 is carried out in the same manner as described in working example 2.

Table 3 show the results of the calculation.

TABLE 3

| Sample | Self-absorption value (SA) |
|---|---|
| Sample 7 | 0.23 |
| (Working example 5) | |
| Sample 8 | 0.26 |
| (Working example 6) | |

1. A semiconducting light emitting nanoparticle comprising a core and at least one shell layer, wherein the semiconducting light emitting nanoparticle has the self-absorption value 0.35 or less.

2. The nanoparticle according to claim 1, wherein the core comprises one element of the group 13 of the periodic table, and one element of the group 15 of the periodic table.

3. The nanoparticle according to claim 1, wherein the shell layer comprises or is consisting of a 1^{st} element of group 12 of the periodic table and a 2^{nd} element of group 16 of the periodic table.

4. The nanoparticle according to claim 1, wherein the shell layer is represented by following formula (II),
ZnSₓSe_{y}Te_{z}, (II)
wherein, 0≤x≤1, 0≤y≤0, 0≤z≤1, and x+y+z=1.

5. The nanoparticle according to claim 1, wherein said shell layer is an alloyed shell layer or a graded shell layer.

6. The nanoparticle according to claim 1, wherein the semiconducting light emitting nanoparticle further comprises a 2^{nd} shell layer onto said shell layer.

7. The nanoparticle according to claim 1, where the volume ratio between the shell and the core is 5 or more.

8. A process for synthesizing the nanoparticle according to claim 1 comprising following steps (a) and (b),
(a) preparing a core by providing at least a first and a second core precursor optionally in a solvent,
(b) providing the core obtained in the step (a) and at least a first cation and a first anion shell precursor, optionally in a solvent, to form a shell layer onto the core.

9. The process according to claim 8, wherein step (b) is carried out at 250° C. or more, preferably, it is in the range from 250° C. to 350° C., more preferably, from 280° C. to 320° C.

10. The process according to claim 8, wherein at least said first anion shell precursor and a second anion shell precursor are added simultaneously in step (b).

11. The process according to claim 8, wherein at least said first anion shell precursor and a second anion shell precursor are added sequentially in step (b).

12. A semiconducting light emitting nanoparticle obtainable or obtained from the process according to claim 8.

13. A composition comprising or consisting of the semiconducting light emitting nanoparticle according to claim 1,
and at least one additional material, preferably the additional material is selected from the group consisting of organic light emitting materials, inorganic light emitting materials, charge transporting materials, scattering particles, and matrix materials.

14. Formulation comprising or consisting of the semiconducting light emitting nanoparticle according to claim 1,
and at least one solvent.

15. An electronic device, optical device or a biomedical device comprising the semiconducting light emitting nanoparticle according to claim 1.

16. An optical medium comprising said semiconducting light emitting nanoparticle according to claim 1.

17. An optical device comprising said optical medium according to claim 16.

18. An electronic device, optical device or a biomedical device comprising the composition according to claim 13.

19. An optical medium comprising the composition according to claim 13.
